(19) United States
(12) Patent Application Publication
(10) Pub. No.: US 2008/0267548 A1
(43) Pub. Date: Oct. 30, 2008

(54) BEARING ARRANGEMENT FOR THE SHAFT OF A TURBO-CHARGER

(75) Inventor: Aaron Chriss, Woodbury, CT (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 12/025,854

(22) Filed: Feb. 5, 2008

Related U.S. Application Data
(60) Provisional application No. 60/888,135, filed on Feb. 5, 2007.

(51) Int. Cl. F16C 33/32

(52) U.S. Cl. 384/492

(57) ABSTRACT

A bearing (1) for the shaft of a turbocharger, which includes two ball bearings spaced apart from each other in the axial direction under axial biasing is provided, wherein the ball bearings are enclosed concentrically by a bearing carrier (4) on the outer periphery and are held at an axial distance by a spacing ring, that is distinguished in that the spacing ring is formed by a lengthened inner ring (7) of one of the two ball bearings (2), both ball bearings (2, 3) belong to different categories, and one of the two ball bearings (2) is charged with axial biasing by a spring element (18).

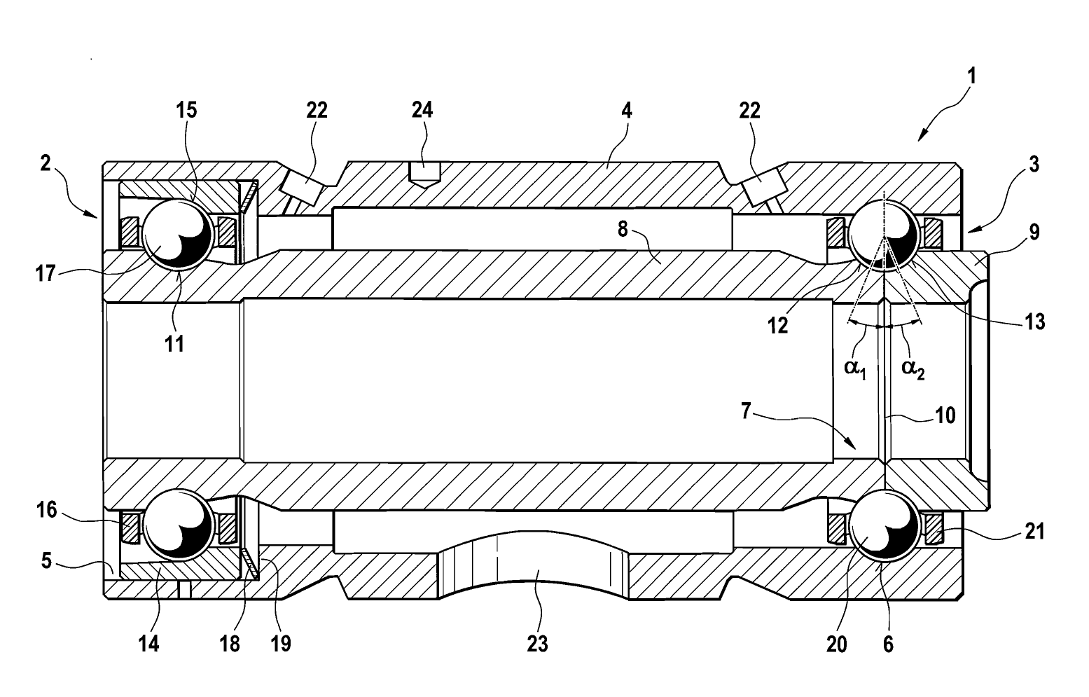

### CROSS-REFERENCE TO RELATED APPLICATION

This application claims the benefit of U.S. Provisional Appln. No. 60/888,135, filed Feb. 5, 2007, which is incorporated herein by reference as if fully set forth.

### FIELD OF THE INVENTION

The invention relates to a bearing for a shaft of a turbocharger, which is locked in rotation at one end to a bladed wheel of a turbine and at the other end to a bladed wheel of a compressor and which is held by two biased ball bearings spaced apart from each other in the axial direction, wherein the ball bearings are surrounded concentrically by a bearing carrier on the outer periphery and are held at an axial distance by a spacing ring.

### BACKGROUND OF THE INVENTION

Turbochargers with a housing are known, in which a shaft is supported rotatably. A turbine is fixed to one end of the shaft and a compressor is arranged at the other end of the shaft. Multiple-part bearings, such as one or more ball bearings, hold the shaft rotatably in the housing. During operation, the outlet of the compressor is connected to the inlet of an internal combustion engine, whose exhaust gas is in active connection with the inlet of the turbine. During operation of the engine, exhaust-gas products of the motor drive the turbine, which in turn drives the compressor, which draws in fresh air, compresses it, and feeds it as compressed air to the engine. For the effective operation of the turbocharger, the shaft of the turbocharger and thus also the turbine and the compressor necessarily rotate at a high rotational speed. Any vibration or play in the bearings therefore leads not only to extraordinarily loud noises, but also to rapid wearing of the bearing and the associated components.

Basic specifications for exhaust-gas turbocharging are to be taken from the reference book “Otto Motor Management,” 2nd edition completely revised and expanded, May 2003, Friedr. Viehweg & Sohn Verlagsgesellschaft mbH, Braunschweig/Wiesbaden on pages 62 to 65.

Special bearings for the shafts of turbochargers are described in the following publications: DE 22 48 440 A1, DE 26 27 527 A1, DE 26 28 828 A1, DE 36 17 402 A1, DE 36 28 687 A1, DE 38 01 590 A1, DE 39 18 323 A1, DE 20 2004 017 194 U1, EP 0 272 151 B1, and EP 0 320 951 B1.

DE 36 17 402 A1 is considered as the closest state of the art and describes a turbocharger with a biased bearing, whose shaft 14 is connected to a compressor 16 and at the other end to a turbine 18, wherein the shaft 14 is supported in a housing by two bearings 48, 50 spaced apart from each other in the axial direction. Both bearings 48, 50 have an inner ring 48, 62 and an outer ring 74, 80, wherein a tubular spacing element 54, which is arranged coaxial to the shaft 14, is positioned between the inner rings 58, 62. The outer rings 74, 80 of both bearings 48, 50 are surrounded by a bearing carrier 40, which is also arranged coaxial to the shaft 14. A first annular spacing bushing 70 is contained in the interior of the bearing carrier 40 and has an axial end 72, which contacts the inner axial end of the bearing race 74 of the first bearing. In a similar way, a second annular spacing bushing 76 is contained in the interior of the bearing carrier 40 and with its outer axial end 78 contacts the inner axial end of the outer bearing surface 80 of the second bearing. An inner axial end 82 of the spacing bushing 76 contacts a part extending radially inward or flange 84 of the bearing carrier 40. A helical compression spring 86 is inserted between the inner axial end 88 of the spacing bushing 70 and the inner axial end of the flange 84 of the bearing carrier. The compression spring 16 is pre-loaded. During operation, it exerts an outward directed axial force on the spacing bushing 70, which in turn exerts an outward directed axial force on the outer bearing race 74 of the first bearing. This outward directed axial force is transmitted via the shaft 14 to the other bearing 50, so that an outward directed axial force is exerted on the outer bearing race 80 of the second bearing. This outward directed force is in turn transmitted via the spacing bushing 76 and the bearing carrier flange 84 to the opposite end of the compression spring 86.

Here it is disadvantageous that such a bearing arrangement according to the class is very expensive due to its many individual components and also very unfriendly with respect to assembly.

### SUMMARY

Starting from the disadvantages of the known state of the art, it would be advantageous to provide an improved bearing for the shaft of a turbocharger with two ball bearings spaced apart from each other, which can be favorably produced and assembled.

According to the invention, the disadvantages of the prior art can be overcome by forming the spacing ring by a lengthened inner ring of one of the two ball bearings, using both ball bearings belong to different categories, and charging one of the two ball bearings by a spring element with axial biasing.

The advantage of the invention lies especially in that very different loads act on the two ball bearings of different categories as a function of their arrangement on the turbine-side end or on the compressor-side end of the exhaust-gas turbocharger during its operation, so that for achieving the longest possible service life of the bearing and the lowest possible noise generation, the two bearings are to be constructed differently for optimum absorption of these loads.

Another advantage is provided in that the bearing according to the invention, as will be explained in more detail below, can get by with a significantly smaller number of individual components, so that it can be favorably produced and assembled.

Other advantageous constructions of the invention are described in detail below.

For example, it has proven to be advantageous that one ball bearing is constructed as an angular-contact ball bearing and the other ball bearing is constructed as a three-point ball bearing. Preferably, here the angular-contact ball bearing is constructed as a movable bearing and the three-point ball bearing is constructed as a fixed bearing. Due to their angle of pressure, angular-contact ball bearings are suitable for absorbing large axial forces, wherein these, however, can be absorbed in only one direction. If there is an axial load, radial forces are also transmitted. The great advantage of the three-point ball bearing is provided in that, in addition to radial forces, it can also absorb axial forces in two directions. For a purely radial load, the ball bearings make contact at three points of their race, while, for an axial load, the contact takes place at two points.

According to another embodiment of the invention, it is provided that an outer race of the angular-contact ball bearing is formed by an outer bearing ring, which is supported in a recess of the bearing carrier so that it can move axially. In this way it is guaranteed that thermal expansions of the shaft can be easily equalized.

According to other embodiments of the invention, the other bearing ring of the angular-contact ball bearing should receive a force from a spring element with axial biasing, wherein this spring element is a disk spring. This arrangement and construction of the spring element also provides for a significant simplification of the bearing construction, because it can be manipulated easily and is in active connection with only one bearing of the bearing arrangement.

According to another additional embodiment of the invention, an outer race of the three-point ball bearing should be set through the bearing carrier and the bearing inner ring should have a two-part construction. The positioning of the outer race through the bearing carrier ensures that an additional bearing outer ring according to prior state of the art can be eliminated. The two-part construction of the inner ring allows, on one side, simplification of the assembly and, on the other side, secure holding of axial forces in both directions.

According to another additional embodiment of the invention, the angular-contact ball bearing should be arranged on the compressor side and the three-point ball bearing should be arranged on the turbine side.

According to another additional feature, it is provided that the bearing carrier has means for preventing its rotation.

Finally, additional preferred embodiments include the lubrication of such a bearing constructed according to the invention. The bearing carrier should preferably have at least one channel for injecting a lubricant into at least one of the ball bearings, wherein the bearing carrier is provided with an opening penetrating a casing of the bearing carrier in the radial direction for the discharge of this lubricant, wherein this opening is arranged in a middle region on the side opposite the channel.

### BRIEF DESCRIPTION OF THE DRAWING

Additional advantages, features, and details of the invention emerge from the following embodiment and from the drawing, in which an embodiment of the invention is shown in simplified form.

The single FIGURE shows an axial section of a bearing according to the invention for the shaft of a turbocharger.

### DETAILED DESCRIPTION OF THE PREFERRED EMBODIMENTS

The bearing according to the invention shown in the single FIGURE and provided with the reference symbol 1 is formed of the angular-contact ball bearing 2 arranged on the left side and the three-point ball bearing 3 arranged on the right side, wherein the angular-contact ball bearing 2 is arranged on the compressor side and the three-point ball bearing 3 is arranged on the turbine side. The two bearings 2, 3 are enclosed concentrically by the bearing carrier 4, which is provided with the recess 5 in the left-side region and has a peripheral ball raceway in the right-side region, which sets the outer race 6 for the three-point ball bearing 3. The bearing inner ring 7 has a two-part construction and consists of the partial ring 8 and the partial ring 9, which contact each other with their end faces at the plane 10. The partial ring 8, which sets the inner race 11 for the angular-contact ball bearing 2, is lengthened in the axial direction up to the plane 10 and thus sets a part of the inner race for the three-point ball bearing 3, which is designated with 12. In this way, the spacing ring, which is necessary according to the state of the art and which holds both bearings at an axial distance, is no longer required. Its task is taken over by the lengthened partial ring 8. The other part of the inner race for the three-point ball bearing 3 is formed by the partial ring 9, wherein this part of the race is provided with the reference symbol 13.

As can be further seen, the angular-contact ball bearing 2 arranged on the left side in the region of the compressor has the bearing outer ring 14, which sets the outer race 15 for the bearing balls 17 guided in the cage 16. The bearing outer ring 14 is displaceably guided via its outer surface in the recess 5 open in the axial direction, wherein in this recess 5 there is a spring element 18 in the form of a disk spring. This spring element 18 is supported on the shoulder 19 of the recess 5 and applies a force directed axially outward onto the bearing outer ring 14, so that the angular-contact ball bearing 2 is biased. The displaceable arrangement of the bearing outer ring 14 in the recess 5 of the bearing carrier 4 ensures that the angular-contact ball bearing 2 functions as a movable bearing, so that axial displacements of a not-shown shaft of a turbocharger can be equalized. The displacements can take place both toward the right and also toward the left, so that thermal changes in length can be equalized in both axial directions.

The three-point ball bearings 3 arranged on the right side in the region of the turbine has bearing balls 20, which are held in the cage 21. The outer race 6 constructed as a ball raceway has a larger radius compared with the bearing balls 20, so that the bearing balls 20 contact the ball raceway 6 in one point. The inner race, which consists of the two partial races 12 and 13, is constructed so that, for radial loading of the shaft, the inner race contacts the individual bearing balls 20 at two points, namely at one point of the partial race 12 and at one point of the partial race 13. In this state of the radial loading of the not-shown shaft of a turbocharger, the bearing balls 20 contact, on one side, the outer race 6 at one point and, on the other side, the partial races 12, 13 also at one point, so that overall a three-point contact is produced. In the case of an axial loading of the shaft, this three-point ball bearing 3 (bearing balls 20, outer race 6, partial race 12, 13), such as an angular-contact ball bearing, i.e., the bearing balls 20, contacts the races 6, 12, 13 in a diametrically opposite way at a point on the outer race 6 and points of the partial races 12, 13. The three-point ball bearing 3 also allows it to be seen that the contact points of the bearing balls 20 on the partial races 12, 13 have the same angle, wherein these angles α1 and α2 are formed by the corresponding contact points on the races 12, 13 and a vertical. This three-point ball bearing 3 acts as a fixed bearing, wherein axial forces can be absorbed in both directions. Through the precise matching of the angular position to the absorption of the forces in two axial directions, an adaptation to each load case is possible in a simple way, wherein the angles can also deviate from each other in magnitude.

As can also be taken from the single FIGURE, the bearing carrier 4 is provided with channels 22, with whose help both bearings 2, 3 can be supplied with lubricant. The channels 22 are arranged at an angle, so that the lubricant can be injected in the direction of the bearing balls 17, 20. The lubricant can here be the oil of a motor oil circuit of an internal combustion engine. In order to lead as much lubricant through the bearing arrangement as possible, which is a necessary requirement at the high temperatures of a turbo bearing, the bearing carrier 4 is also provided with the opening 23, which is opposite the channels 22 and provides unimpaired discharge of the lubricant. Finally, the FIGURE also allows it to be seen that the bearing carrier 4 has on its outer surface the recess, which is designated with 24 and which acts as a rotational lock, when another part is brought into engagement in this recess.

### REFERENCE SYMBOLS

1 Bearing
2 Angular-contact ball bearing
3 Three-point ball bearing
4 Bearing carrier
5 Recess
6 Outer race
7 Bearing inner ring
8 Partial ring
9 Partial ring
10 Plane
11 Inner race
12 Partial race
13 Partial race
14 Bearing outer ring
15 Outer race
16 Cage
17 Bearing ball
18 Spring element
19 Shoulder
20 Bearing ball
21 Cage
22 Channel
23 Opening
24 Recess
α1/α2 Inclination angle

1. A bearing (1) for a shaft of a turbocharger, which is locked in rotation at one end with a bladed wheel of a turbine and at an other end with a bladed wheel of a compressor, the bearing comprising two ball bearings that support the shaft that are spaced apart from each other in an axial direction and that are set under axial biasing, the ball bearings are enclosed concentrically by a bearing carrier (4) on an outer periphery and are held at an axial distance by a spacing ring, the spacing ring is formed by an elongated inner ring (7) of one of the two ball bearings (2), each of the ball bearings (2, 3) belongs to a different category of ball bearings, and one of the two ball bearings (2) is charged by a spring element (18) with axial biasing.

2. A bearing (1) according to claim 1, wherein one of the ball bearings comprises an angular-contact ball bearing (2) and the other of the ball bearings comprises a three-point ball bearing (3).

3. A bearing (1) according to claim 2, wherein an outer race (15) of the angular-contact ball bearing (2) is formed by an outer bearing ring (14), which is displaceably supported in the axial direction in a recess (5) of the bearing carrier (4).

4. A bearing (1) according to claim 3, wherein an outer bearing ring (14) of the angular-contact ball bearing (2) is charged by the spring element (18) with axial biasing.

5. A bearing (1) according to claim 4, wherein the spring element (18) is a disk spring.

6. A bearing (1) according to claim 2, wherein an outer race (6) of the three-point ball bearing (3) is provided in the bearing carrier (4) and the bearing inner ring (7) has a two-part construction.

7. A bearing (1) according to claim 2, wherein the angular-contact ball bearing (2) is arranged on a compressor side and the three-point ball bearing (3) is arranged on a turbine side.

8. A bearing (1) according to claim 1, wherein the bearing carrier (4) includes an anti-rotation element.

9. A bearing (1) according to claim 1, wherein the bearing carrier (4) includes at least one channel (22) for injecting a lubricant into at least one of the ball bearings (2, 3).

10. A bearing (1) according to claim 1, wherein the bearing carrier (4) is provided with an opening (23) that penetrates through a casing of the bearing carrier (4) in a radial direction for discharge of a lubricant.

11. A bearing (1) according to claim 10, wherein the opening (23) is arranged in a middle region on a side opposite the channel (22).
